(19) United States
(12) Patent Application Publication
(10) Pub. No.: US 2025/0005216 A1
(43) Pub. Date: Jan. 2, 2025

(54) RESERVOIR SCHEDULING METHOD CONSIDERING POWER GENERATION, ECOLOGICAL FLOW, AND SURFACE WATER TEMPERATURE

(71) Applicant: Dalian University of Technology, Dalian City (CN)

(72) Inventors: Zhuohang XIN, Dalian City (CN); Longfan WANG, Dalian City (CN); Bo XU, Dalian City (CN); Chi ZHANG, Dalian City (CN)

(73) Assignee: Dalian University of Technology, Dalian City, LN (CN)

(21) Appl. No.: 18/605,997

(22) Filed: Mar. 15, 2024

(30) Foreign Application Priority Data
Jun. 28, 2023 (CN) 202310774016.7

(51) Int. Cl. G06F 30/13

(52) U.S. Cl. CPC G06F 30/13

(57) ABSTRACT

The present disclosure provides a reservoir scheduling method considering power generation, an ecological flow, and a surface water temperature. A plurality of optimization objectives of power generation, an ecological flow, and a surface water temperature of a reservoir are determined through analysis, and a multi-objective optimization model is constructed. A non-dominated sorting genetic algorithm III (NSGAII) algorithm is used to obtain an optimal value of a to-be-optimized parameter through solving. Scheduling control is performed on the reservoir based on the optimal value of the to-be-optimized parameter. The present disclosure quantifies a competitive and cooperative relationship among the power generation, the ecological flow, and the surface water temperature of the reservoir by using a multi-objective optimization method, and a reservoir scheduling rule that can balance the power generation, the ecological flow, and the surface water temperature of the reservoir is selected through analysis.

### CROSS REFERENCE TO RELATED APPLICATION

This patent application claims the benefit and priority of Chinese Patent Application No. 202310774016.7, filed with the China National Intellectual Property Administration on Jun. 28, 2023, the disclosure of which is incorporated by reference herein in its entirety as part of the present application.

### TECHNICAL FIELD

The present disclosure relates to the technical field of water environment management of reservoirs, and in particular, to a reservoir scheduling method considering power generation, an ecological flow, and a surface water temperature.

### BACKGROUND

Reservoir construction provides a large amount of electric energy for social and economic development, but also brings many negative impacts to an ecological environment. For example, in a reservoir scheduling process, water storage is carried out during a flood season to increase a generating capacity, but this will reduce a downstream flow during the flood season. This is not conducive to migration and spawning of fish, causing a significant decrease in a fish diversity. Therefore, a reservoir is required to meet a minimum “ecological flow” demand during power generation scheduling. In addition, the water storage of the reservoir will also significantly increase a surface water temperature and stratify a vertical water temperature in a reservoir area during summer, causing an increase in toxic blue-green algae, oxygen deficiency in a deep water body, deterioration of water quality, and other negative impacts. In this regard, people have attempted to explore impacts of water level and flow changes of the reservoir on a water temperature, and tried to weaken water temperature stratification by reducing a water level and increasing a discharged flow. This alleviates an environmental problem caused by the water temperature, but also reduces the generating capacity to a certain extent.

Therefore, it can be seen that there is a complex competitive and cooperative relationship among the generating capacity, an ecological flow, and the surface water temperature of the reservoir. How to balance the relationship among the generating capacity, the ecological flow, and the surface water temperature of the reservoir is of utmost importance in promoting sustainable development of the reservoir construction. However, there is currently no reservoir scheduling method that can quantify the complex competitive and cooperative relationship among the: generating capacity, the ecological flow, and the surface water temperature of the reservoir and comprehensively consider the generating capacity, the ecological flow, and the surface water temperature of the reservoir.

### SUMMARY

The present disclosure is intended to provide a reservoir scheduling method considering power generation, an ecological flow, and a surface water temperature, which balances a generating capacity, an ecological flow, and a surface water temperature in reservoir scheduling, and promotes sustainable development of reservoir construction.

To achieve the above objective, the present disclosure provides following technical solutions.

A reservoir scheduling method considering power generation, an ecological flow, and a surface water temperature includes following steps:
constructing a multi-objective optimization scheduling model of a reservoir, where the multi-objective optimization scheduling model of the reservoir includes a sub-objective function for a maximum generating capacity of the reservoir, a sub-objective function for a maximum ecological flow guarantee rate, and a sub-objective function for a minimum quantity of days with a high surface water temperature, and the sub-objective function for the maximum generating capacity of the reservoir, the sub-objective function for the maximum ecological flow guarantee rate, and the sub-objective function for the minimum quantity of days with the high surface water temperature are all functions related to a to-be-optimized parameter in a reservoir scheduling rule;
solving the multi-objective optimization scheduling model of the reservoir by using a non-dominated sorting genetic algorithm III (NSGAII) algorithm, to obtain an optimal value of the to-be-optimized parameter; and
performing scheduling control on the reservoir based on the optimal value of the to-be-optimized parameter.

Optionally, the reservoir scheduling rule includes a reduced output zone, a standard output zone, a first increased output zone, and a second increased output zone, where each zone corresponds to one output control line, and each output control line corresponds to a basic water storage capacity, water storage capacity reduction time, a reduced water storage capacity, water storage capacity increase time, and an output coefficient; and the basic water storage capacity, the water storage capacity reduction time, the reduced water storage capacity, the water storage capacity increase time, and the output coefficient that are corresponding to each output control line form the to-be-optimized parameter.

Optionally, the sub-objective function for the maximum generating capacity of the reservoir: is as follows:

$$max HB = {\sum }_{t = 1}^{12} {P}_{t} \cdot Δ {t}_{1} \\ {P}_{t} = 3600 \times ( {QG}_{t} / R ) {h}_{t}$$

where HB represents a generating capacity of the reservoir, Pₜ represents a generated output in a t^{th} month, _{Δt}l represents a total quantity of power generation hours in the t^{th} month, QGₜ represents a power generation flow of the reservoir in the t^{th} month, R represents a water consumption rate of power generation of the reservoir, and hₜ represents a difference between upstream and downstream water levels in the t^{th} month.

Optionally, a calculation formula for the generated output in the t^{th} month is as follows:

$${P}_{t} = \{ \begin{matrix}{c}_{1} \cdot {P}_{g} & {S}_{t} ∈ Zone 1 \\ 1 \cdot {P}_{g} & {S}_{t} ∈ Zone 2 \\ {c}_{2} \cdot {P}_{g} & {S}_{t} ∈ Zone 3 \\ {c}_{3} \cdot {P}_{g} & {S}_{t} ∈ Zone 4\end{matrix}$$

where 0<c₁<1<c₂<c₃, S^{min}<Sₜ<S^{max}, Sₜ represents a water storage capacity at the beginning of the t^{th} month, S^{min} represents a minimum allowable storage capacity of the reservoir, Sₘₐₓ represents a maximum storage capacity of the reservoir, Zone1 represents the reduced output zone, Zone2 represents the standard output zone, Zone3 represents the first increased output zone, Zone4 represents the second increased output zone, and P_{g} represents a guaranteed output for the power generation of the reservoir.

Optionally, the sub-objective function for the maximum ecological flow guarantee rate is as follows:

$$max FR = {\sum }_{t = a}^{b} δ ( {QR}_{t} ) / ( b - a + 1 ) \\ δ ( {QR}_{t} ) = \{ \begin{matrix}1 & {QR}_{t} \geq {QR}_{eco} \\ 0 & {QR}_{t} < {QR}_{eco}\end{matrix}$$

where FR represents an ecological flow guarantee rate, a and b respectively represent start and end months of a fish spawning season, QRₜ represents a discharged flow of the reservoir in a t^{th} month, and QR_{eco} represents an ecological flow.

Optionally, the sub-objective function for the minimum quantity of days with the high surface water temperature is as follows:

$$min TD = {\sum }_{d = 1}^{D} τ ( {SWT}_{d} ) \\ τ ( {SWT}_{d} ) = \{ \begin{matrix}1 & {SWT}_{d} \geq 25 ° C . \\ 0 & {SWT}_{d} < 25 ° C .\end{matrix}$$

where TD represents a quantity of days with the high surface water temperature, D represents a total quantity of days per year, and SWT_{d} represents a surface water temperature on a d^{th} day; and the quantity of days with the high surface water temperature is a quantity of days with a surface water temperature greater than or equal to 25° C.

Optionally, the reservoir scheduling method further includes:
calculating a surface water temperature of the reservoir based on a surface water temperature simulation model, where the surface water temperature simulation model is constructed based on a relationship among meteorological data, hydrological data, and a water temperature, and the hydrological data includes an inbound flow, a discharged flow, and a water level.

Optionally, the solving the multi-objective optimization scheduling model of the reservoir by using an NSGAII algorithm specifically includes:
generating an initial population including a plurality of individuals, where in the initial population, each of the individuals corresponds to to-be-optimized parameters in one set of reservoir scheduling rules;
calculating a corresponding generating capacity, ecological flow guarantee rate, and quantity of days with the high surface water temperature for any one of the individuals.
performing non-dominated sorting and crowding degree sorting on the initial population based on a corresponding generating capacity, ecological flow guarantee rate, and quantity of days with the high surface water temperature of each of the individuals in the initial population;
taking the initial population as a parent population;
performing selection, crossover, and mutation operations on an individual in the parent population to obtain an offspring population;
merging the offspring population and the parent population to obtain a composite population with 2N individuals;
calculating a corresponding generating capacity, ecological flow guarantee rate, and quantity of days with the high surface water temperature for any one of the individuals in the composite population;
performing the non-dominated sorting and the crowding degree sorting on the composite population based on a corresponding generating capacity, ecological flow guarantee rate, and quantity of days with the high surface water temperature of each of the individuals in the composite population, and taking top N individuals as an intermediate population; and
taking the intermediate population as a new parent population, and performing the step of “performing selection, crossover, and mutation operations on an individual in the parent population to obtain an offspring population” until a preset quantity of iterations is reached, to obtain an optimal individual.

Optionally, when the corresponding generating capacity, ecological flow guarantee rate, and quantity of days with the high surface water temperature of each of the individuals are calculated, following constraints are met:

$${S}_{t + 1} = {S}_{t} + ( {QI}_{t} - {QR}_{t} ) \cdot Δ {t}_{2} \\ {QR}_{t} = {QG}_{t} + {QS}_{t} \\ {QR}_{t} , {QG}_{t} , {QS}_{t} , {S}_{t} \geq 0 \\ {Q}_{t}^{min} \leq {QR}_{t} \leq {Q}_{t}^{max} \\ {QG}_{t} \leq {QG}_{max} \\ {P}_{t} \leq IC \\ {\sum }_{t = 1}^{12} ξ ( {P}_{t} ) / 12 \geq C \\ ξ ( {P}_{t} ) = \{ \begin{matrix}1 & {P}_{t} \geq {P}_{min} \\ 0 & {P}_{t} < {P}_{min}\end{matrix}$$

where Sₜ₊₁ represents a water storage capacity at the beginning of a (t+1)^{th} month, Sₜ represents a water storage capacity at the beginning of a t^{th} month, QIₜ represents an inbound flow in the t^{th} month, QRₜ represents a discharged flow in the t^{th} month, Δt₂ represents a total quantity of power generation seconds in the t^{th} month, QGₜ represents a power generation flow in the t^{th} month, QSₜ represents an abandoned water flow in the t^{th} month, Qₜ^{min} represents a minimum discharged flow of the reservoir, Qₜ^{max} represents a maximum allowable discharged flow of the reservoir, QGₘₐₓ represents a maximum power generation flow of the reservoir, Pₜ represents a generated output in the t^{th} month, IC represents an installed storage capacity of the reservoir, C represents a guarantee rate of the generated output, and Pₘᵢₙ represents a required minimum generated output.

According to specific embodiments provided in the present disclosure, the present disclosure has following technical effects:

According to the reservoir scheduling method considering power generation, an ecological flow, and a surface water temperature provided in the present disclosure, a plurality of optimization objectives of power generation, an ecological flow, and a surface water temperature of a reservoir are determined through analysis, and a multi-objective optimization model is constructed. An NSGAII algorithm is used to obtain an optimal value of a to-be-optimized parameter through solving. Scheduling control is performed on the reservoir based on the optimal value of the to-be-optimized parameter. The present disclosure quantifies a competitive and cooperative relationship among the power generation, the ecological flow, and the surface water temperature of the reservoir by using a multi-objective optimization method, and a reservoir scheduling rule that can balance the power generation, the ecological flow, and the surface water temperature of the reservoir is selected through analysis based on the NSGAII algorithm. This ensures a generating capacity of the reservoir, ensures a growth environment of downstream fish of the reservoir, reduces a risk of excessive algae proliferation in a reservoir area, and promotes sustainable development of reservoir construction.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can be derived from these accompanying drawings by those of ordinary skill in the art without creative efforts.

FIG. 1 is a flowchart of a reservoir scheduling method considering power generation, an ecological flow, and a surface water temperature according to Embodiment 1 of the present disclosure;

FIG. 2 is a schematic diagram of a reservoir scheduling graph in a reservoir scheduling method according to Embodiment 1 of the present disclosure;

FIG. 3 is a flowchart of a step A2 in a reservoir scheduling method according to Embodiment 1 of the present disclosure;

FIG. 4 to FIG. 6 are Pareto solution distribution diagrams drawn in a reservoir scheduling method according to Embodiment 1 of the present disclosure;

FIGS. 7A-D are schematic diagrams of three typical schemes B, Q, and T in a reservoir scheduling method according to Embodiment 1 of the present disclosure; and

FIG. 8 is a schematic structural diagram of a reservoir scheduling system considering power generation, an ecological flow, and a surface water temperature according to Embodiment 2 of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

The present disclosure is intended to provide a reservoir scheduling method considering power generation, an ecological flow, and a surface water temperature, which balances a generating capacity, an ecological flow, and a surface water temperature in reservoir scheduling, and promotes sustainable development of reservoir construction.

In order to make the above objectives, features, and advantages of the present disclosure clearer and more comprehensible, the present disclosure will be further described in detail below in combination with the accompanying drawings and particular implementations.

### Embodiment 1

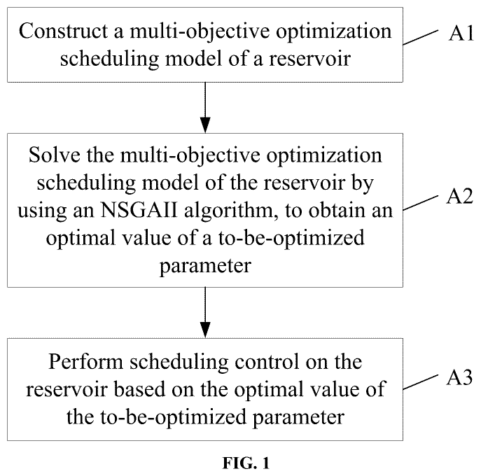

This embodiment provides a reservoir scheduling method considering power generation, an ecological flow, and a surface water temperature. As shown in FIG. 1, the method includes following steps.
A1. Construct a multi-objective optimization scheduling model of a reservoir. The multi-objective optimization scheduling model of the reservoir includes a sub-objective function for a maximum generating capacity of the reservoir, a sub-objective function for a maximum ecological flow guarantee rate, and a sub-objective function for a minimum quantity of days with a high surface water temperature. The sub-objective function for the maximum generating capacity of the reservoir, the sub-objective function for the maximum ecological flow guarantee rate, and the sub-objective function for the minimum quantity of days with the high surface water temperature are all functions related to a to-be-optimized parameter in a reservoir scheduling rule.
A2: Solve the multi-objective optimization scheduling model of the reservoir by using an NSGAII algorithm, to obtain an optimal value of the to-be-optimized parameter.
A3: Perform scheduling control on the reservoir based on the optimal value of the to-be-optimized parameter.

In specific implementation, a plurality of optimization objectives for reservoir scheduling-based power generation considering an ecological environment can be determined based on reservoir data. The reservoir data includes reservoir engineering data, historical reservoir runoff data, and historical meteorological data. Based on the collected reservoir data, an environmental problem of the reservoir is analyzed, ecological environment problems in upstream and downstream regions of the reservoir are clarified, and a relationship between the ecological problem and a flow and a water temperature of the reservoir is analyzed.

The obtained reservoir engineering data may include a characteristic water level of the reservoir, a water level-storage capacity relationship curve, a power generation capability of the: reservoir, a water consumption rate curve of power generation of the reservoir, a reservoir scheduling constraint, and the like. The reservoir runoff data is a long-term monthly inbound flow of the reservoir. The meteorological data includes a temperature, radiation relative humidity, and a wind speed of each day. Existing ecological environmental problems of the reservoir that need to be analyzed mainly include downstream fish species, a fish diversity change before and after reservoir construction, a suitable growth condition for fish, a type and a density of an alga in a reservoir area, and a suitable growth condition for the alga.

A target generating capacity is a required total generating capacity of the reservoir, and an optimization objective is to maximize a generating capacity of the reservoir, as shown in following formulas:

$$max HB = {\sum }_{t = 1}^{12} {P}_{t} \cdot Δ {t}_{1} \qquad ( 1 )$$

$${P}_{t} = 3600 \times ( {QG}_{t} / R ) {h}_{t} \qquad ( 2 )$$

In the above formulas, HB represents the generating capacity of the reservoir, Pₜ represents a generated output in a t^{th} month, Δt₁ represents a total quantity of power generation hours in the t^{th} month, QGₜ represents a power generation flow of the reservoir in the t^{th} month, R represents a water consumption rate of the power generation of the reservoir, which reflects a flow required to generate a unit generating capacity at a specific water level and is usually known, and hₜ represents a difference between upstream and downstream water levels in the t^{th} month, namely, an average water head. The upstream water level is obtained based on a current water storage capacity and the water level-storage capacity relationship curve, and it is found through observation that the downstream water level is basically maintained at a fixed value.

A calculation formula for the generated output in the t^{th} month is as follows:

$${P}_{t} = \{ \begin{matrix}{c}_{1} \cdot {P}_{g} & {S}_{t} ∈ Zone 1 \\ 1 \cdot {P}_{g} & {S}_{t} ∈ Zone 2 \\ {c}_{2} \cdot {P}_{g} & {S}_{t} ∈ Zone 3 \\ {c}_{3} \cdot {P}_{g} & {S}_{t} ∈ Zone 4\end{matrix} \qquad ( 3 )$$

$$0 < {c}_{1} < 1 < {c}_{2} < {c}_{3} \qquad ( 4 )$$

$${S}^{min} < {S}_{t} < {S}^{max} \qquad ( 5 )$$

In the above formulas, Sₜ represents a water storage capacity at the beginning of the t^{th} month, S^{min} represents a minimum allowable storage capacity of the reservoir, S^{max} represents a maximum storage capacity of the reservoir, Zone1 represents a reduced output zone, Zone2 represents a standard output zone, Zone3 represents a first increased output zone, Zone4 represents a second increased output zone, and P_{g} represents a guaranteed output for the power generation of the reservoir. An average output that a hydropower station of the reservoir can produce to correspond to a designed guarantee rate during a long period of operation is referred to as the guaranteed output for the power generation of the reservoir in the hydropower station. In actual scheduling, power should be generated as much as possible based on a required guaranteed output for the power generation of the reservoir.

A target ecological flow guarantee rate is a required ecological flow guarantee rate. The ecological flow guarantee rate is a ratio of duration in which a discharged flow of the reservoir meets a spawning demand of downstream fish to total duration of a fish spawning season. An optimization objective is to maximize the ecological flow guarantee rate, as shown in following formulas:

$$max FR = {\sum }_{t = a}^{b} δ ( {QR}_{t} ) / ( b - a + 1 ) \qquad ( 6 )$$

$$δ ( {QR}_{t} ) = \{ \begin{matrix}1 & {QR}_{t} \geq {QR}_{eco} \\ 0 & {QR}_{t} < {QR}_{eco}\end{matrix} \qquad ( 7 )$$

In the above formulas, FR represents the ecological flow guarantee rate, a and b respectively represent start and end months of the fish spawning season (an a^{th} month and a b^{th} month), QRₜ represents a discharged flow of the reservoir in the t^{th} month, and QR_{eco} represents an ecological flow.

A target quantity of days with the high surface water temperature is a required quantity of days with the high surface water temperature for the reservoir within a year. Generally, when a surface water temperature of the reservoir is above 25° C., a blue-green alga grows at a fastest speed. Therefore, a quantity of days with the high surface water temperature is a quantity of days with the surface water temperature greater than 25° C. An optimization objective is to minimize the quantity of days with the high surface water temperature, as shown in following formulas:

$$min TD = {\sum }_{d = 1}^{D} τ ( {SWT}_{d} ) \qquad ( 8 )$$

$$τ ( {SWT}_{d} ) = \{ \begin{matrix}1 & {SWT}_{d} \geq 25 ° C . \\ 0 & {SWT}_{d} < 25 ° C .\end{matrix}$$

In the above formulas, TD represents the quantity of days with the high surface water temperature, D represents a total quantity of days per year, and SWT_{d} represents a surface water temperature on a d^{th} day; and the quantity of days with the high surface water temperature is a quantity of days with the surface water temperature greater than or equal to 25° C.

In order to accurately calculate the sub-objective function for the minimum quantity of days with the high surface water temperature, it is necessary to ensure that the surface water temperature is accurately simulated. Therefore, in this embodiment, the reservoir scheduling method may further include:
calculating the surface water temperature of the reservoir based on a surface water temperature simulation model, where the surface water temperature simulation model is constructed based on a relationship among meteorological data, hydrological data, and a water temperature, the hydrological data includes an inbound flow, a discharged flow, and a water level, and based on this model, a simulated surface water temperature is more accurate.

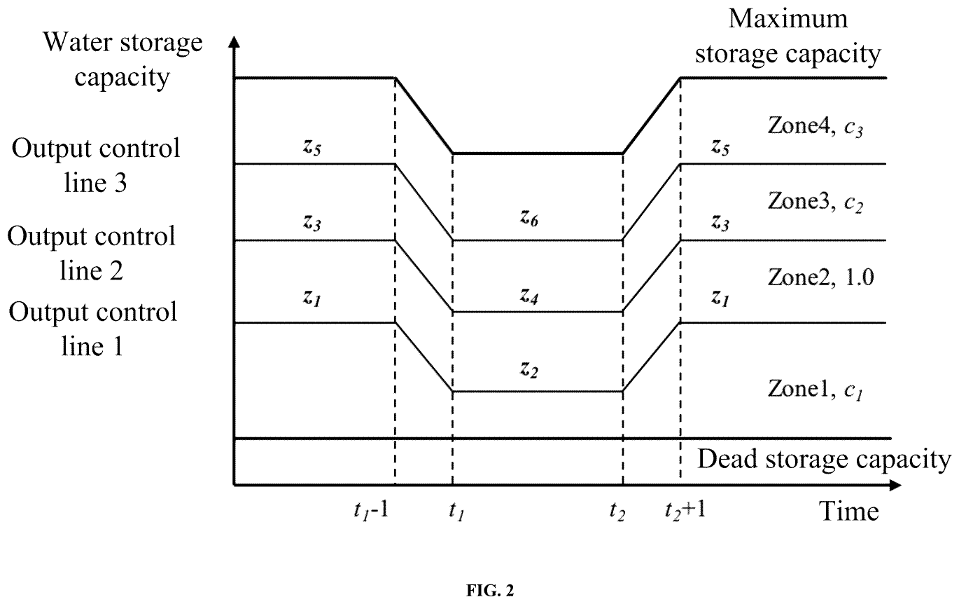

Generally, the reservoir scheduling rule can be illustrated in a diagram. As shown in FIG. 2, the reservoir scheduling rule includes the reduced output zone, the standard output zone, the first increased output zone, and the second increased output zone. Each zone corresponds to one output control line, and each output control line corresponds to a basic water storage capacity, water storage capacity reduction time, a reduced water storage capacity, water storage capacity increase time, and an output coefficient. The basic water storage capacity, the water storage capacity reduction time, the reduced water storage capacity, the water storage capacity increase time, and the output coefficient that are corresponding to each output control line form the to-be-optimized parameter.

Specifically, in this embodiment, the basic water storage capacity and the reduced water storage capacity constitute a water storage capacity variable group. The basic water storage capacity includes {z₁, z₃, z₅}, and the reduced water storage capacity includes {z₂, z₄, z₆}. The water storage capacity increase time and the water storage capacity reduction time constitute a time variable group {t₁, t₂}, where the t₁ and the t₂ respectively represent the water storage capacity reduction time and the water storage capacity increase time. An output coefficient of each zone other than the standard output zone constitutes an output coefficient group {c₁, c₂, c₃}.

Three generated output control lines can be determined based on the water storage capacity variable group and the time variable group. Based on the three generated output control lines, a storage capacity of the reservoir at an allowable minimum water level, and the maximum storage capacity of the reservoir, a storage capacity of the reservoir can be divided into four output zones: the reduced output zone, the standard output zone, the first increased output zone, and the second increased output zone. As shown in FIG. 2, the four output zones are the reduced output zone Zone1, the standard output zone Zone2, the first increased output zone Zone3, and the second increased output zone Zone4 in sequence from bottom to top.

When a water storage capacity at the beginning of a month is in the reduced output zone, a required generated output of the reservoir is determined by using the c₁ as the output coefficient. When the water storage capacity at the beginning of the month is in the standard output zone, the required generated output of the reservoir is determined by using the c₁ as the output coefficient. When the water storage capacity at the beginning of the month is in the first increased output zone, the required generated output of the reservoir is determined by using the c₂ as the output coefficient. When the water storage capacity at the beginning of the month is in the second increased output zone, the required generated output of the reservoir is determined by using the c₃ as the output coefficient.

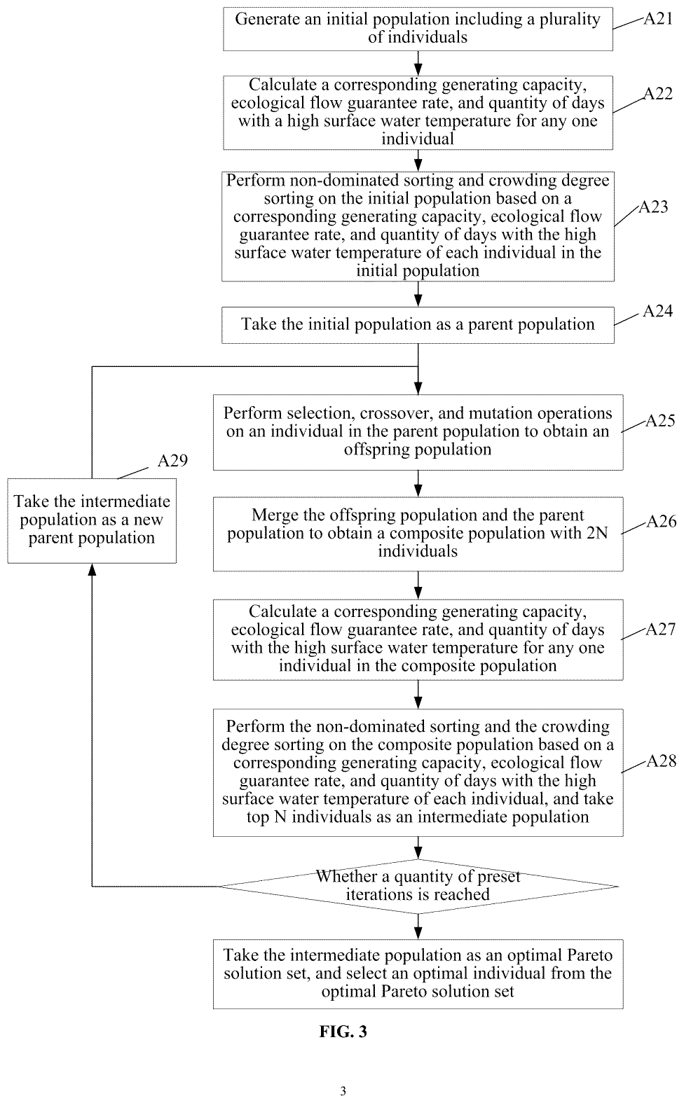

In this embodiment, as shown in FIG. 3, the step A2 specifically includes following sub-steps:
A21. Generate an initial population including a plurality of individuals, where in the initial population, each individual corresponds to to-be-optimized parameters in one set of reservoir scheduling rules. The to-be-optimized parameters in the reservoir scheduling rules are randomly generated within their respective value ranges, and the randomly generated to-be-optimized parameters collectively constitute one individual in the initial population.
A22. Calculate a corresponding generating capacity, ecological flow guarantee rate, and quantity of days with the high surface water temperature for any one individual.
A23. Perform non-dominated sorting and crowding degree sorting on the initial population based on a corresponding generating capacity, ecological flow guarantee rate, and quantity of days with the high surface water temperature of each individual in the initial population.
A24. Take the initial population as a parent population.
A25. Perform selection, crossover, and mutation operations on an individual in the parent population to obtain an offspring population.
A26. Merge the offspring population and the parent population to obtain a composite population with 2N individuals.
A27. Calculate a corresponding generating capacity, ecological flow guarantee rate, and quantity of days with the high surface water temperature for any one individual in the composite population.
A28. Perform the non-dominated sorting and the crowding degree sorting on the composite population based on a corresponding generating capacity, ecological flow guarantee rate, and quantity of days with the high surface water temperature of each individual in the composite population, and take top N individuals as an intermediate population.

Whether a preset quantity of iterations is reached is determined. If the preset quantity of iterations is not reached, step A29 is performed. If the preset quantity of iterations is reached, the intermediate population obtained in the step A28 is used as an optimal Pareto solution set, and an optimal individual is selected from the optimal Pareto solution set.
A29. Take the intermediate population as a new parent population, and perform the step A25.

In this embodiment, when the corresponding generating capacity, ecological flow guarantee: rate, and quantity of days with the high surface water temperature of each individual are calculated, following constraints need to be met:

$${S}_{t + 1} = {S}_{t} + ( Q {I}_{t} - Q {R}_{t} ) \cdot Δ {t}_{2} \qquad ( 10 )$$

In the formula (10), Sₜ₊₁ represents a water storage capacity at the beginning of a (t+1)^{th} month, Sₜ represents the water storage capacity at the beginning of the t^{th} month, QIₜ represents an inbound flow in the t^{th} month, QRₜ represents the discharged flow in the t^{th} month, and Δt₂ represents a calculation time step, where a total quantity of power generation seconds in the t^{th} month is calculated herein. In other words, the water storage capacity at the beginning of the (t+1)^{th} month should be equal to the water storage capacity at the beginning of the t^{th} month plus a product of a net discharged flow in the t^{th} month and a quantity of hours in the current month.

$$Q {R}_{t} = Q {G}_{t} + Q {S}_{t} \qquad ( 11 )$$

In the formula (11), QGₜ represents the power generation flow in the t^{th} month, and QSₜ represents an abandoned water flow in the t^{th} month. In other words, the discharged flow in the t^{th} month should be a sum of the power generation flow in the t^{th} month and the abandoned water flow in the t^{th} month. Generally, QR=QG, which means that inbound water should be used for power generation as much as possible. However, when a maximum output is exceeded, QS is generated.

$$Q {R}_{t} , Q {G}_{t} , Q {S}_{t} , {S}_{t} \geq 0 \qquad ( 12 )$$

As shown in the formula (12), the discharged flow, the power generation flow, the abandoned water flow, and the water storage capacity at the beginning of the month should all be greater than or equal to 0.

$${Q}_{t}^{min} \leq Q {R}_{t} \leq {Q}_{t}^{max} \qquad ( 13 )$$

In the formula (13), Qₜ^{min} represents a minimum discharged flow of the reservoir, and Qₜ^{max} represents a maximum allowable discharged flow of the reservoir. In other words, the discharged flow should be between the minimum discharged flow of the reservoir and the maximum allowable discharged flow of the reservoir.

$$Q {G}_{t} \leq Q {G}_{max} \qquad ( 14 )$$

In the formula (14), QGₘₐₓ represents a maximum power generation flow of the reservoir, which means that the power generation flow should be less than the maximum power generation flow. In this case, a surplus obtained by removing the power generation flow from the discharged flow is considered as the abandoned water flow.

$${P}_{t} \leq IC \qquad ( 15 )$$

In the formula (15), Pₜ represents the generated output in the t^{th} month, and IC represents an installed storage capacity of the reservoir.

$${\sum }_{t = 1}^{12} ξ ( {P}_{t} ) / 12 \geq C \qquad ( 16 )$$

$$ξ ( {P}_{f} ) = \{ \begin{matrix}1 & {P}_{t} \geq {P}_{min} \\ 0 & {P}_{t} < {P}_{min}\end{matrix} \qquad ( 17 )$$

In the formulas (16) and (17), C represents a guarantee rate of the generated output, and Pₘᵢₙ represents a required minimum generated output.

In specific implementation, when the corresponding generating capacity, ecological flow guarantee rate, and quantity of days with the high surface water temperature of each individual are calculated, it is necessary to use a corresponding reservoir scheduling rule of the individual to perform trial calculation for reservoir scheduling, which can specifically include following steps:

Given the water storage capacity SI of the reservoir at the beginning of the month, a current generated output zone and a corresponding value of the required generated output Pₜ are determined in a scheduling graph. Assuming that a water storage capacity of the reservoir at the end of the month (namely, the water storage capacity Sₜ₊₁ at the beginning of the next month) reaches the maximum storage capacity, and there is no abandoned water QSₜ, in other words, QRₜ=QGₜ, according to the formulas (10), (11), and (2), the discharged flow QRₜ within the month and the generated output Pₜ within the month can be calculated based on the water storage capacity Sₜ at the beginning of the month and the inbound flow QIₜ within the month.

If the value of the output Pₜ meets an output requirement and does not exceed the installed storage capacity IC of the reservoir, the power generation is carried out based on the output. If the value of the output exceeds the installed storage capacity IC of the reservoir, the power generation is carried out based on the installed storage capacity IC, and a part of the discharged flow QRₜ exceeding the power generation flow QGₜ is used as the abandoned water flow QSₜ. If the value of the output is less than the required generated output, the water storage capacity of the reservoir at the end of the month is reduced, in other words, the discharged flow QR is increased, and the generated output is adjusted until it meets the output requirement. If the output requirement is still not met when the water storage capacity at the end of the month decreases to a dead storage capacity, the power generation is carried out based on a generated output corresponding to the dead storage capacity.

After trial calculation is completed for the current month, an output of the next month is calculated, until outputs of all months are calculated, to obtain a monthly generated output, discharged flow, water storage capacity, and water level of the reservoir.

A total generating capacity is calculated based on the monthly generated output and time. The ecological flow guarantee rate is calculated based on the monthly discharged flow and an ecological flow demand. In addition, monthly water level data is interpolated into daily water level: data. Based on daily meteorological data (a temperature, radiation, relative humidity, and a wind speed), a daily surface water temperature is calculated by using the surface water temperature simulation model, and the quantity of days with the high surface water temperature is determined according to the formulas (8) and (9).

The surface water temperature simulation model in this embodiment is a surrogate model for establishing a hydrodynamic model based on a machine learning model, which can achieve fast and accurate simulation of the water temperature. A main procedure is as follows:

Firstly, a Delft3D hydrodynamic model of the reservoir is established based on terrain, meteorological (the temperature, the radiation, the relative humidity, and the wind speed), hydrological (the inbound flow, the discharged flow, and the water level), and water temperature data (an inbound water temperature and a vertical water temperature in front of a dam). Then, based on long-sequence meteorological and hydrological data (the temperature, the radiation, the relative humidity, the wind speed, the inbound flow, and the discharged flow), a long-term surface water temperature process is generated by using the Delft3D hydrodynamic model. After that, a long short-term memory network (LSTM) neural network model is trained by using the meteorological data and the water level as input data and the surface water temperature as output data.

For example, the Delft3D hydrodynamic model of the reservoir is established based on the terrain data of the reservoir, as well as short-term daily meteorological data (the temperature, the radiation, the relative humidity, and the wind speed), hydrological data (the inbound flow, the discharged flow, and the water level), and water temperature data (the inbound water temperature and the vertical water temperature in front of the dam) from 2014 to 2017. Then, long-term local meteorological data (the temperature, the radiation, the relative humidity, and the wind speed) and hydrological data (the inbound flow) of the reservoir from 1980 to 2009 are collected, and a discharged flow of the reservoir under a given inbound flow condition is calculated based on a reservoir scheduling graph provided by a power station. After that, based on the long-term meteorological, inbound flow, inbound water temperature, and discharged flow data from 1980 to 2009, the Delft3D model is used to perform simulation to generate long-term surface water temperature data of the reservoir from 1980 to 2009. Then, the LSTM model is trained by using the long-term meteorological (the temperature, the radiation, the relative humidity, and the wind speed), hydrological (the water level), and surface water temperature data from 1980 to 2009.

After a trained LSTM neural network model is obtained, the monthly water level data of the reservoir can be obtained based on an initial water storage capacity and the monthly inbound flow of the reservoir under a corresponding scheduling rule of each individual. The daily water level data of the reservoir can be obtained by interpolating the monthly water level data of the reservoir. The daily water level data of the reservoir and the daily meteorological data are input into the trained: LSTM neural network model to obtain daily surface water temperature data of the reservoir. It should be noted that the water level data of the reservoir is affected by the scheduling rule. The monthly inbound flow data and the daily meteorological data are real historical data, while the initial water storage capacity is a manually predetermined value. For example, in this embodiment, the historical data of 30 years from 1980 to 2009 is used. Specifically, historical monthly inbound flow data can be obtained based on 30-year flow data of an upstream river of the reservoir from 1980 to 2009, and the initial water storage capacity is preset to 90% of a normal water storage capacity designed for the reservoir at the beginning of 1980.

In the NSGAII algorithm, when it is determined that the preset quantity of iterations is reached, the intermediate population obtained in the step A28 is used as the optimal Pareto solution set, and the optimal individual is selected from the optimal Pareto solution set. This step specifically includes:

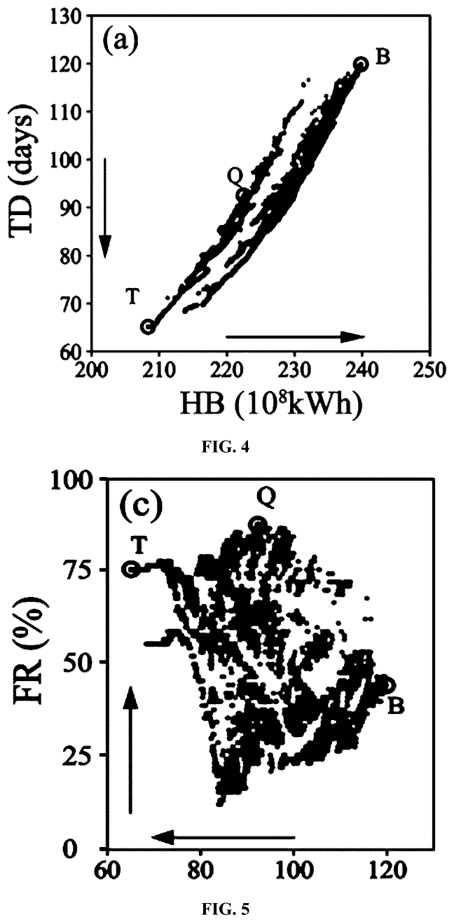

A Pareto solution distribution diagram for every two optimization objectives is drawn based on the Pareto solution set. Pareto solution distribution diagrams drawn are shown in FIG. 4 to FIG. 6. After the Pareto solution distribution diagram for every two targets is drawn, intensity of a competitive relationship between targets can be determined based on a distribution range of a Pareto frontier curve. Based on the Pareto solution distribution diagram for every two optimization objectives, the optimal individual is determined, and an optimal reservoir scheduling rule, namely, the optimal value of the to-be-optimized parameter, is obtained. The optimal reservoir scheduling rule is a reservoir scheduling rule that simultaneously meets the target generating capacity, the target ecological flow guarantee rate, and the target quantity of days with the high surface water temperature. Based on the drawn Pareto solution distribution diagram, a competitive and cooperative relationship among a plurality of targets can be intuitively understood. A scheduling scheme performing well in all the three targets is selected as an optimal reservoir scheduling scheme.

After the optimal reservoir scheduling rule is obtained, in a specific application, the performing scheduling control on the reservoir based on the optimal value of the to-be-optimized parameter in the step A3 may specifically include: when the initial water storage capacity and the monthly inbound flow are given, calculating the monthly water level and discharged flow according to the reservoir scheduling rule.

With a specific case, the following illustrates the reservoir scheduling method considering power generation, an ecological flow, and a surface water temperature provided in this embodiment.

This case takes the Nuozhadu reservoir as a research object. The Nuozhadu reservoir is located on a main stream of the Lancang River in Simao District of Pu'er city in Yunnan province. A reservoir scheduling method for the Nuozhadu reservoir mainly includes following steps:
B1. Collect reservoir data. Reservoir engineering data is obtained from the Nuozhadu hydropower station. A total storage capacity of the Nuozhadu reservoir is 23.703 billion cubic meters, and a maximum dam height is 261.5 meters. A dead water level is 765 meters, a flood limit water level is 804 meters, and a normal water storage level is 812 meters. A total installed capacity reaches 5.85 million kilowatts, with an average annual generating capacity of 23.912 billion kilowatt-hours. A water level-storage capacity relationship curve of the reservoir and a water consumption rate curve of power generation of the reservoir are obtained. Runoff data is obtained, including monthly runoff data of 30 years from 1980 to 2009, which is provided by the hydropower station. Meteorological data is obtained from the National Meteorological Science Data Center, including daily temperature, radiation, relative humidity, and wind speed data from 1980 to 2009.

Existing problems in an ecological environment of the reservoir are analyzed. After the Nuozhadu reservoir is constructed, a discharged flow in a fish spawning period significantly decreases, significantly decreasing a diversity of downstream fish. Existing research shows that a main fish spawning season in Nuozhadu ranges from July to September, with a corresponding ecological flow demand of 2500 m³/s. A surface water temperature of a reservoir area is significantly increased, with a maximum surface water temperature rising from 23° C. to 27° C., which promotes growth of a blue-green alga and increases a density of the blue-green alga in the reservoir area during summer.

Based on the existing problems in the ecological environment of the reservoir, it can be determined that a first optimization objective is to achieve a maximum generating capacity; a second optimization objective is to achieve a maximum ecological flow guarantee rate, where an ecological flow is a discharged flow from July to September, which should meet 2500 m³/s; and a third optimization objective is to achieve a minimum quantity of days with a high surface water temperature. The three optimization objectives are expressed in formulas (18) to (23):

$$max HB = {\sum }_{t = 1}^{12} {P}_{t} \cdot Δ t \qquad ( 18 )$$

$${P}_{t} = 3600 \times Q {G}_{t} / R ( {h}_{t} ) \qquad ( 19 )$$

$$max FR = {\sum }_{t = 7}^{9} δ ( Q {R}_{t} ) / 3 \qquad ( 20 )$$

$$δ ( {QR}_{t} ) = \{ \begin{matrix}1 & {QR}_{t} \geq 2500 \\ 0 & {QR}_{t} < 2500\end{matrix} \qquad ( 21 )$$

$$min TD = {\sum }_{d = 1}^{D} τ ( {SWT}_{d} ) \qquad ( 22 )$$

$$τ ( {SWT}_{d} ) = \{ \begin{matrix}1 & {SWT}_{d} \geq 25 \\ 0 & {SWT}_{d} < 25\end{matrix} \qquad ( 23 )$$

B2. Construct a multi-objective optimization scheduling model of the reservoir, where the multi-objective optimization scheduling model of the reservoir includes the sub-objective function for the maximum generating capacity of the reservoir, the sub-objective function for the maximum ecological flow guarantee rate, and the sub-objective function for the minimum quantity of days with the high surface water temperature.

Based on the reservoir data, a guaranteed output P_{g} of the hydropower station is 2.406 million kilowatts. Based on a runoff process in Nuozhadu, a flood season in a basin where the Nuozhadu reservoir is located is around May to October. Therefore, a time variable constraint is added to a scheduling graph:

$$4 \leq {t}_{1} \leq 6 and 8 \leq {t}_{2} \leq 11 \qquad ( 24 )$$

In other words, water storage capacity increase time and water storage capacity reduction time should be within a few months of the beginning and end of the flood season respectively. Other constraints that should be met in a reservoir scheduling process, as shown in the above formulas (10) to (17), are not described herein again. A maximum power generation flow QGₘₐₓ of the hydropower station is 3500 m³/s, and a maximum output, namely, an installed capacity IC, of the reservoir is 5.85 million kilowatts. A required minimum output Pₘᵢₙ of the hydropower station is 0.7 P_{g}. A power generation guarantee rate C is 50%.

Based on a reservoir scheduling graph and inbound flow data, a trial calculation method is used to calculate a monthly generated output, discharged flow, and water level, so as to calculate a generating capacity and an ecological flow guarantee rate.

In addition, monthly water level data is interpolated into daily water level data. Based on daily meteorological data (a temperature, radiation, relative humidity, and a wind speed), a daily surface water temperature is calculated by using a surface water temperature simulation model, and a quantity of days with the high surface water temperature is determined according to the formulas (8) and (9).

A modeling process of the surface water temperature simulation model used in this case is as follows: A Delft3D hydrodynamic model of the Nuozhadu reservoir is established based on terrain data of Nuozhadu, as well as daily meteorological data (a temperature, radiation, relative humidity, and a wind speed), hydrological data (an inbound flow, a discharged flow, and a water level), and water temperature data (an inbound water temperature and a vertical water temperature in front of a dam) from 2014 to 2017. Then, local meteorological data (a temperature, radiation, relative humidity, and a wind speed) and hydrological data (an inbound flow) from 1980 to 2009 are collected, and a discharged flow of the reservoir under a given inbound flow condition is calculated based on the reservoir scheduling graph provided by the Nuozhadu power station. After that, based on the meteorological, inbound flow, inbound water temperature, and discharged flow: data, the Delft3D model is used to perform simulation to generate long-term surface water temperature data. Then, an LSTM model is trained by using the meteorological (the temperature, the radiation, the relative humidity, and the wind speed), hydrological (the water level), and surface water temperature data. The LSTM model includes an input layer, an LSTM layer, a fully connected layer, and an output layer. The LSTM layer contains 30 LSTM cells. The model takes temperatures, radiation, relative humidity, wind speeds, and water levels in the past 60 days as input data to predict a current surface water temperature. The model uses a mean square error (MSE) as a loss function and Adam as an optimization method. After verification, a correlation coefficient between a surface water temperature simulated by a trained LSTM model and a surface water temperature simulated by the Delft3D model is 0.99.
B3. Use an NSGAII algorithm to solve a multi-objective optimization problem.

An initial population including 500 individuals is randomly generated.

For each individual, simulation is performed according to the previous step to obtain a target generating capacity, a target ecological flow guarantee rate, and a target quantity of days with the high surface water temperature. Dominated sorting and crowding degree calculation are performed on the initial population. The initial population is taken as a parent population, and selection, crossover, and mutation operations are performed on an individual in the parent population to obtain an offspring population. A polynomial mutation distribution coefficient is 20, a mutation rate is 0.09, a crossover distribution coefficient is 20, and a crossover rate is 1.0.

After the offspring population is obtained, the offspring population and the parent population are merged to obtain a composite population with 2N individuals. Then an individual in the composite population is simulated, and the non-dominated sorting and the crowding degree calculation are performed to generate an intermediate population with N individuals. The intermediate population is taken as a new parent population, and the step of performing the selection, crossover, and mutation operations on the individual in the parent population to obtain the offspring population is repeated. When a quantity of iterations reaches 2000, the iteration stops, and a last intermediate population is taken as a final Pareto solution set.

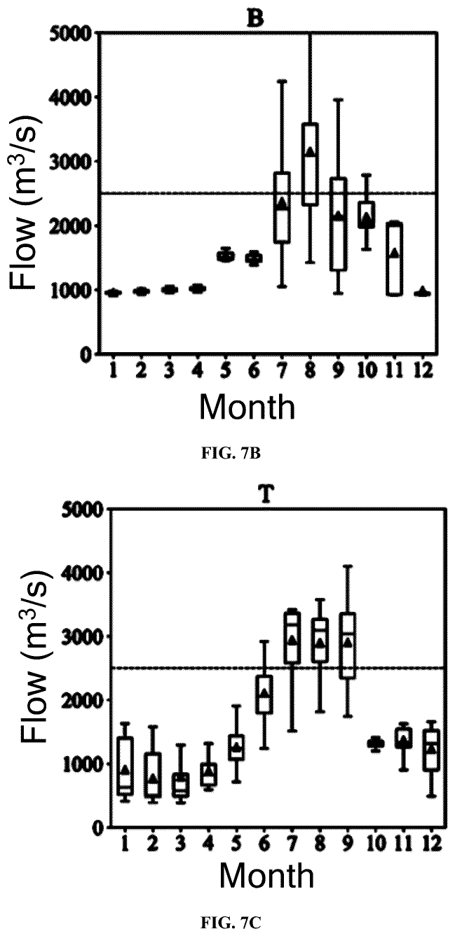

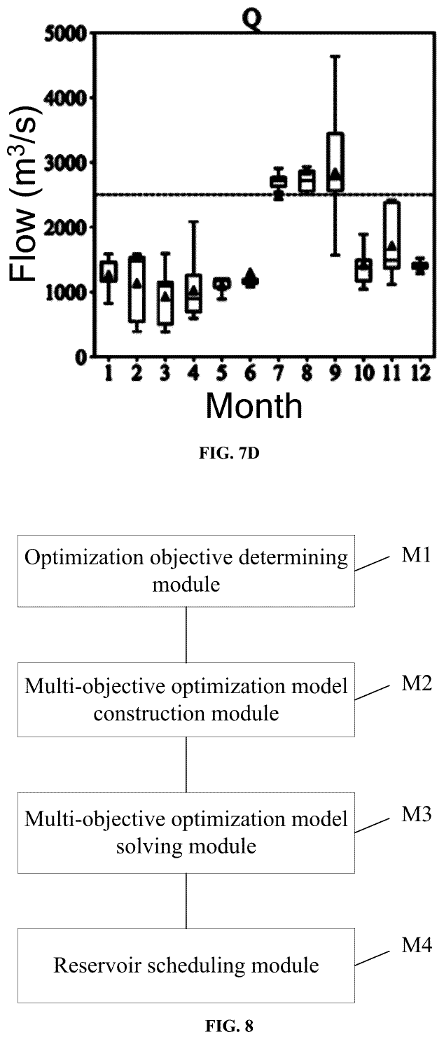

Based on an optimized Pareto solution set, a Pareto solution set distribution diagram for every two targets is drawn, as shown in FIG. 4 to FIG. 6. A competitive and cooperative relationship among a plurality of targets is analyzed by using a visualization technology. Three typical schemes B, Q, and T shown in FIGS. 7A-D are adopted. In the scheme B, a maximum generating capacity is achieved. In the scheme Q, a maximum ecological guarantee rate is achieved. In the scheme T, a minimum quantity of days with the high surface water temperature is achieved.

As shown in FIG. 4, there is a strong competitive relationship between the target generating capacity and the target water temperature, and a Pareto frontier is widely distributed (marked with a: black point). Generally, a higher generating capacity leads to a larger quantity of days with the high surface water temperature. Specifically, the scheme T achieves 65.1 days with the high surface water temperature, but a corresponding generating capacity is only 20.83 billion kilowatt-hours. The scheme T has the minimum quantity of days with the high surface water temperature, as it maintains a relatively low reservoir water level. As shown in FIGS. 7A-D, there is a short distance between surface water and an intake, and reservoir discharge disturbs a water body between a surface and the intake. This weakens water temperature stratification, and promotes exchange of a vertical water body and heat, thereby reducing the surface water temperature and decreasing the quantity of days with the high surface water temperature. On the contrary, the scheme B has the maximum generating capacity, reaching 23.98 billion kilowatt-hours, but also has a maximum quantity of days with the high surface water temperature, reaching 119.8 days. The scheme B maintains a relatively high water level and increases the generating capacity by increasing a water head. However, the high water level also strengthens the water temperature stratification, suppresses the exchange of the vertical water body and the heat, and thus increases the surface water temperature, thereby correspondingly increasing the quantity of days with the high surface water temperature.

As shown in FIG. 5, there is also a competitive relationship between the generating capacity and the ecological flow, and the Pareto frontier is widely distributed. The scheme Q has the maximum ecological flow guarantee rate, reaching 88%, and a corresponding generating capacity is 22.25 billion kilowatt-hours. Generally, a higher generating capacity leads to a lower ecological flow guarantee rate. This is because a scheme with a large generating capacity increases the water level (an intake head) of the reservoir to increase the generating capacity at the cost of reducing the discharged flow. However, there is also a cooperative relationship between the ecological flow and the generating capacity. Compared with the scheme T, the scheme Q has a relatively high water level (water storage capacity) in a spawning season. Therefore, in dry years, when the inbound flow of the reservoir is lower than a required ecological flow, the reservoir can increase the discharged flow to meet the required ecological flow. On the contrary, the scheme T has a water level close to the dead water level, has a limited regulation capability, and cannot guarantee a downstream ecological flow in the dry years.

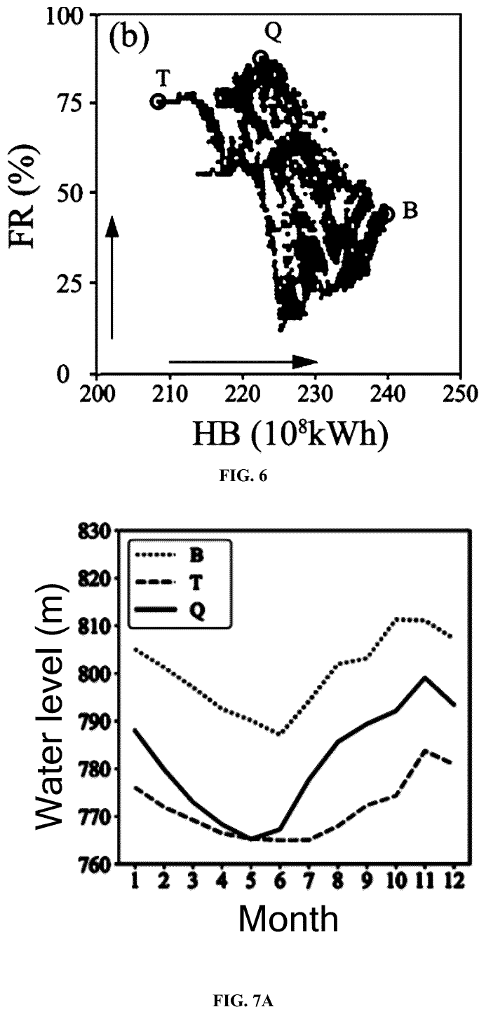

As shown in FIG. 6, there is an overall cooperative relationship between the target quantity of days with the high surface water temperature and the target ecological flow. A smaller quantity of days with the high surface water temperature leads to a larger ecological flow guarantee rate. But there is also a certain competitive relationship. Compared with the scheme T, the scheme Q has a relatively high water level to ensure that the ecological flow can still be met in the dry years, but the high water level also promotes the water temperature stratification and increases the surface water: temperature.

In summary, it is recommended to adopt the scheme Q in this case, which has the maximum ecological flow guarantee rate and balances the generating capacity and the quantity of days with the high surface water temperature. In addition, considering that the scheme Q still has 92 days with the high surface water temperature, other supporting measures are also needed to prevent and control a blue-green alga, including: (1) controlling input of nutrients into the reservoir, including controlling input of feed for fish farming in the reservoir, and performing soil and water conservation on a reservoir slope; (2) reducing light exposure through shading and other means, and lowering the surface water temperature; (3) destroying the water temperature stratification through aeration and other means to reduce the surface water temperature; and (4) monitoring a concentration of the blue-green alga in the reservoir area and promptly removing the blue-green alga.

This embodiment quantifies the competitive and cooperative relationship among the reservoir power generation, the ecological flow, and the surface water temperature by using a multi-objective optimization method, and selects, through visualized analysis, a scheduling rule that can balance the reservoir power generation, the ecological flow, and the surface water temperature. This ensures a growth environment of downstream fish of the reservoir, reduces a risk of excessive algae proliferation in the reservoir area, and promotes sustainable development of reservoir construction. In addition, the case based on the actual data of the Nuozhadu reservoir verifies feasibility and effectiveness of the reservoir scheduling method provided in this embodiment.

### Embodiment 2

In addition, the reservoir scheduling method in Embodiment 1 of the present invention can also be implemented with the help of an architecture of a reservoir scheduling system shown in FIG. 8. As shown in FIG. 8, the reservoir scheduling system may include an optimization objective determining module M1, a multi-objective optimization model construction module M2, a multi-objective optimization model solving module M3, and a reservoir scheduling module M4. Some modules may also have subunits for implementing their functions. For example, the multi-objective optimization model solving module M3 further includes a population generation unit, a scheduling rule trial calculation unit, a non-dominated sorting unit, a crowding degree calculation unit, a cross processing unit, and a mutation processing unit. Certainly, the architecture shown in FIG. 8 is only illustrative. When different functions are implemented, one or at least two components of the reservoir scheduling system shown in FIG. 8 can be omitted based on an actual need.

Specific examples are used herein, but the above description is only a description of the principle and implementations of the present disclosure, and the above embodiments are only used to help understand the method of the present disclosure and its core ideas. Those skilled in the art should understand that the above modules or steps of the present disclosure can be implemented by means of a general-purpose computer device, or optionally, by means of a program code executable by a computing device, such that they can be stored in a storage device and executed by a computing device, or they can be made separately into integrated circuit modules, or a plurality of modules or steps in them are made into a single integrated circuit module for implementation. The present disclosure is not limited to any specific hardware and software combination.

In addition, those of ordinary skill in the art can make various modifications in terms of specific implementations and the scope of application according to the ideas of the present disclosure. In conclusion, the content of this specification shall not be construed as limitations to the present disclosure.

What is claimed is:

1. A reservoir scheduling method considering power generation, an ecological flow, and a surface water temperature, comprising:
constructing a multi-objective optimization scheduling model of a reservoir, wherein the multi-objective optimization scheduling model of the reservoir comprises a sub-objective function for a maximum generating capacity of the reservoir, a sub-objective function for a maximum ecological flow guarantee rate, and a sub-objective function for a minimum quantity of days with a high surface water temperature, and the sub-objective function for the maximum generating capacity of the reservoir, the sub-objective function for the maximum ecological flow guarantee rate, and the sub-objective function for the minimum quantity of days with the high surface water temperature are all functions related to a to-be-optimized parameter in a reservoir scheduling rule;
solving the multi-objective optimization scheduling model of the reservoir by using a non-dominated sorting genetic algorithm III (NSGAII) algorithm, to obtain an optimal value of the to-be-optimized parameter; and
performing scheduling control on the reservoir based on the optimal value of the to-be-optimized parameter.

2. The reservoir scheduling method considering power generation, an ecological flow, and a surface water temperature according to claim 1, wherein the reservoir scheduling rule comprises a reduced output zone, a standard output zone, a first increased output zone, and a second increased output zone, wherein each zone corresponds to one output control line, and each output control line corresponds to a basic water storage capacity, water storage capacity reduction time, a reduced water storage capacity, water storage capacity increase time, and an output coefficient; and the basic water storage capacity, the water storage capacity reduction time, the reduced water storage capacity, the water storage capacity increase time, and the output coefficient that are corresponding to each output control line form the to-be-optimized parameter.

3. The reservoir scheduling method considering power generation, an ecological flow, and a surface water temperature according to claim 1, wherein the sub-objective function for the maximum generating capacity of the reservoir is as follows:
$$max HB = {\sum }_{t = 1}^{12} {P}_{t} \cdot Δ {t}_{1}$$
$${P}_{t} = 3600 \times ( Q {G}_{t} / R ) {h}_{t}$$
wherein HB represents a generating capacity of the reservoir, Pₜ represents a generated output in a t^{th} month, Δt₁ represents a total quantity of power generation hours in the t^{th} month, QGₜ represents a power generation flow of the reservoir in the t^{th} month, R represents a water consumption rate of power generation of the reservoir, and hₜ represents a difference between upstream and downstream water levels in the t^{th} month.

4. The reservoir scheduling method considering power generation, an ecological flow, and a surface water temperature according to claim 3, wherein a calculation formula for the generated output in the t^{th} month is as follows:
$${P}_{t} = \{ \begin{matrix}{c}_{1} \cdot {P}_{g} & {S}_{t} ∈ Zone 1 \\ 1 \cdot {P}_{g} & {S}_{t} ∈ Zone 2 \\ {c}_{2} \cdot {P}_{g} & {S}_{t} ∈ Zone 3 \\ {c}_{3} \cdot {P}_{g} & {S}_{t} ∈ Zone 4\end{matrix}$$
wherein 0<c₁<1<c₂<c₃, S^{min}<Sₜ<S^{max}, Sₜ represents a water storage capacity at the beginning of the t^{th} month, S^{min} represents a minimum allowable storage capacity of the reservoir, S^{max} represents a maximum storage capacity of the reservoir, Zone1 represents the reduced output zone, Zone2 represents the standard output zone, Zone3 represents the first increased output zone, Zone4 represents the second increased output zone, and P_{g} represents a guaranteed output for the power generation of the reservoir.

5. The reservoir scheduling method considering power generation, an ecological flow, and a surface water temperature according to claim 1, wherein the sub-objective function for the maximum ecological flow guarantee rate is as follows:
$$max FR = {\sum }_{t = a}^{b} δ ( Q {R}_{t} ) / ( b - a + 1 )$$
$$δ ( Q {R}_{t} ) = \{ \begin{matrix}1 & {QR}_{t} \geq Q {R}_{e c o} \\ 0 & {QR}_{t} < {QR}_{e c o}\end{matrix}$$
wherein FR represents an ecological flow guarantee rate, a and b respectively represent start and end months of a fish spawning season, QRₜ represents a discharged flow of the reservoir in a t^{th} month, and QR_{eco} represents an ecological flow.

6. The reservoir scheduling method considering power generation, an ecological flow, and a surface water temperature according to claim 1, wherein the sub-objective function for the minimum quantity of days with the high surface water temperature is as follows:
$$min TD = {\sum }_{d = 1}^{D} τ ( {SWT}_{d} )$$
$$τ ( {SWT}_{d} ) = \{ \begin{matrix}1 & {SWT}_{d} \geq 25 ° C . \\ 0 & {SWT}_{d} < 25 ° C .\end{matrix}$$
wherein TD represents a quantity of days with the high surface water temperature, D represents a total quantity of days per year, and SWT_{d} represents a surface water temperature on a d^{th} day; and the quantity of days with the high surface water temperature is a quantity of days with a surface water temperature greater than or equal to 25° C.

7. The reservoir scheduling method considering power generation, an ecological flow, and a surface water temperature according to claim 6, further comprising:
calculating a surface water temperature of the reservoir based on a surface water temperature simulation model, wherein the surface water temperature simulation model is constructed based on a relationship among meteorological data, hydrological data, and a water temperature, and the hydrological data comprises an inbound flow, a discharged flow, and a water level.

8. The reservoir scheduling method considering power generation, an ecological flow, and a surface water temperature according to claim 1, wherein the solving the multi-objective optimization scheduling model of the reservoir by using an NSGAII algorithm specifically comprises:
generating an initial population comprising a plurality of individuals, wherein in the initial population, each of the individuals corresponds to to-be-optimized parameters in one set of reservoir scheduling rules;
calculating a corresponding generating capacity, ecological flow guarantee rate, and quantity of days with the high surface water temperature for any one of the individuals;
performing non-dominated sorting and crowding degree sorting on the initial population based on a corresponding generating capacity, ecological flow guarantee rate, and quantity of days with the high surface water temperature of each of the individuals in the initial population;
taking the initial population as a parent population;
performing selection, crossover, and mutation operations on an individual in the parent population to obtain an offspring population;
merging the offspring population and the parent population to obtain a composite population with 2N individuals;
calculating a corresponding generating capacity, ecological flow guarantee rate, and quantity of days with the high surface water temperature for any one of the individuals in the composite population;
performing the non-dominated sorting and the crowding degree sorting on the composite population based on a corresponding generating capacity, ecological flow guarantee rate, and quantity of days with the high surface water temperature of each of the individuals in the composite population, and taking top N individuals as an intermediate population; and
taking the intermediate population as a new parent population, and performing the step of “performing selection, crossover, and mutation operations on an individual in the parent population to obtain an offspring population” until a preset quantity of iterations is reached, to obtain an optimal individual.

9. The reservoir scheduling method considering power generation, an ecological flow, and a surface water temperature according to claim 8, wherein when the corresponding generating capacity, ecological flow guarantee rate, and quantity of days with the high surface water temperature of each of the individuals are calculated, following constraints are met:
$${S}_{t + 1} = {S}_{t} + ( Q {I}_{t} - Q {R}_{t} ) \cdot Δ {t}_{2}$$
$$Q {R}_{t} = Q {G}_{t} + Q {S}_{t}$$
$$Q {R}_{t} , Q {G}_{t} , Q {S}_{t} , {S}_{t} \geq 0$$
$${Q}_{t}^{min} \leq Q {R}_{t} \leq {Q}_{t}^{max}$$
$$Q {G}_{t} \leq Q {G}_{max}$$
$${P}_{t} \leq IC$$
$${\sum }_{t = 1}^{12} ξ ( {P}_{t} ) / 12 \geq C$$
$$ξ ( {P}_{t} ) = \{ \begin{matrix}1 & {P}_{t} \geq {P}_{min} \\ 0 & {P}_{t} < {P}_{min}\end{matrix} \begin{matrix} \\ \end{matrix}$$
wherein Sₜ₊₁ represents a water storage capacity at the beginning of a (t+1)^{th} month, Sₜ represents a water storage capacity at the beginning of a t^{th} month, QIₜ represents an inbound flow in the t^{th} month, QRₜ represents a discharged flow in the t^{th} month, Δt₂ represents a total quantity of power generation seconds in the t^{th} month, QGₜ represents a power generation flow in the t^{th} month, QSₜ represents an abandoned water flow in the t^{th} month, Qₜ^{min} represents a minimum discharged flow of the reservoir, Qₜ^{max} represents a maximum allowable discharged flow of the reservoir, QGₘₐₓ represents a maximum power generation flow of the reservoir, Pₜ represents a generated output in the t^{th} month, IC represents an installed storage capacity of the reservoir, C represents a guarantee rate of the generated output, and Pₘᵢₙ represents a required minimum generated output.
